(19) United States
(12) Patent Application Publication
(10) Pub. No.: US 2009/0019975 A1
(43) Pub. Date: Jan. 22, 2009

(54) TORQUE WRENCH FOR USE WITH GOLF CLUB

(75) Inventor: MATTHEW T. CACKETT, SAN DIEGO, CA (US)

Correspondence Address: CALLAWAY GOLF C0MPANY, 2180 RUTHERFORD ROAD, CARLSBAD, CA, 92008-7328, US

(73) Assignee: CALLAWAY GOLF COMPANY, CARLSBAD, CA (US)

(21) Appl. No.: 12/113,430

(22) Filed: May 1, 2008

Related U.S. Application Data
(60) Provisional application No. 60/915,799, filed on May 3, 2007.

(51) Int. Cl. B25B 23/142; B25B 23/157

(52) U.S. Cl. 81/478

(57) ABSTRACT

A torque wrench for a golf club includes a body and a handle. The body has a notch formed therein with an interface for engaging a geometrically-shaped head of a mechanical fastener. The handle includes a free end and an attached end, the latter of which is pivotably connected to the body by a hinge. The handle is movable between a stowed position and a deployed position. When the handle is in the stowed position, the free end of the handle abuts the body and the torque wrench has a generally disc-like shape.

### CROSS REFERENCE TO RELATED APPLICATIONS

The present application claims priority to pending U.S. Provisional Application No. 60/915,799, filed on May 3, 2007.

### STATEMENT REGARDING FEDERALLY SPONSORED RESEARCH OR DEVELOPMENT

Not Applicable

### BACKGROUND OF THE INVENTION

1. Field of the Invention

The present invention relates to a torque wrench, and more particularly to a compact torque wrench for use with a golf club.

2. Description of the Related Art

In order to improve their game, golfers often customize their equipment to fit their particular swing. Golf equipment manufacturers have responded by increasing the variety of clubs available to golfers. For example, a particular model of a driver-type golf club may be offered in several different loft angles and lie angles to suit a particular golfer's needs. In addition, golfers can choose shafts, whether metal or graphite, and adjust the length of the shaft to suit their swing. Golf clubs that allow shaft and club head components to be easily interchanged facilitate this customization process.

One example is Wheeler, U.S. Pat. No. 3,524,646 for a Golf Club Assembly. The Wheeler patent discloses a putter having a grip and a putter head, both of which are detachable from a shaft. Fastening members, provided on the upper and lower ends of the shaft, have internal threads, which engage the external threads provided on both the lower end of the grip and the upper end of the putter head shank to secure these components to the shaft. The lower portion of the shaft further includes a flange, which contacts the upper end of the putter head shank, when the putter head is coupled to the shaft.

Two further examples are published applications to Burrows, U.S. Pub. Nos. 2004/0018886 and 2004/0018887, both of which are for a Temporary Golf Club Shaft-Component Connection. The Burrows applications disclose a temporary connection that includes an adapter insert, a socket member, and a mechanical fastener. The adapter insert, which is mounted on a shaft, includes a thrust flange. The socket member, which is mounted on the other golf club component (e.g., a club head), includes a thrust seat for seated reception of the thrust flange. The mechanical fastener (e.g., a compression nut or a lock bolt) removably interconnects the adapter insert and the socket member.

Still other examples include Cackett et al., U.S. Pat. No. 7,083,529, and Evans, U.S. Pat. No. 7,115,046, both of which are assigned to the assignee of the present invention and hereby incorporated by reference in their entireties. The Cackeft et al. and Evans patents disclose various interchangeable golf club head and shaft connections that utilize a mechanical fastener, such as a screw or bolt, to secure a shaft to a golf club head.

Many of the above-mentioned references require a tool, such as a socket wrench or screwdriver, to tighten the mechanical fastener and secure the shaft to the golf club head. Ideally, the mechanical fastener is tightened to a specific amount to prevent the shaft from accidentally detaching from the golf club head. There is a need, therefore, for a torque wrench with a predetermined or selectively variable torque applied onto a shank by a spring biasing member and/or a spherical coupling member that can create an audible indication to the operator of when the predetermined or selectively variable torque is applied. It is desirable that the torque wrench be compact for placement on a golf fitting cart or in golf bag.

### BRIEF SUMMARY OF THE INVENTION

The present invention provides a compact torque wrench for use with a golf club. In accordance with one embodiment of the invention, a torque wrench includes a body and a handle. The body has a notch formed therein with an interface for engaging a head of a mechanical fastener. The mechanical fastener may have a hex-shaped, or any other geometrically-shaped, head. The handle includes a free end and an attached end, the latter of which is pivotably connected to the body by a hinge. The handle is movable between a stowed position and a deployed position. When the handle is in the stowed position, the free end of the handle abuts the body and the torque wrench has a generally disc-like shape.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a top plan view of a torque wrench in accordance with the present invention.

FIG. 2 is a rear plan view of the torque wrench of FIG. 1.

### DETAILED DESCRIPTION OF THE INVENTION

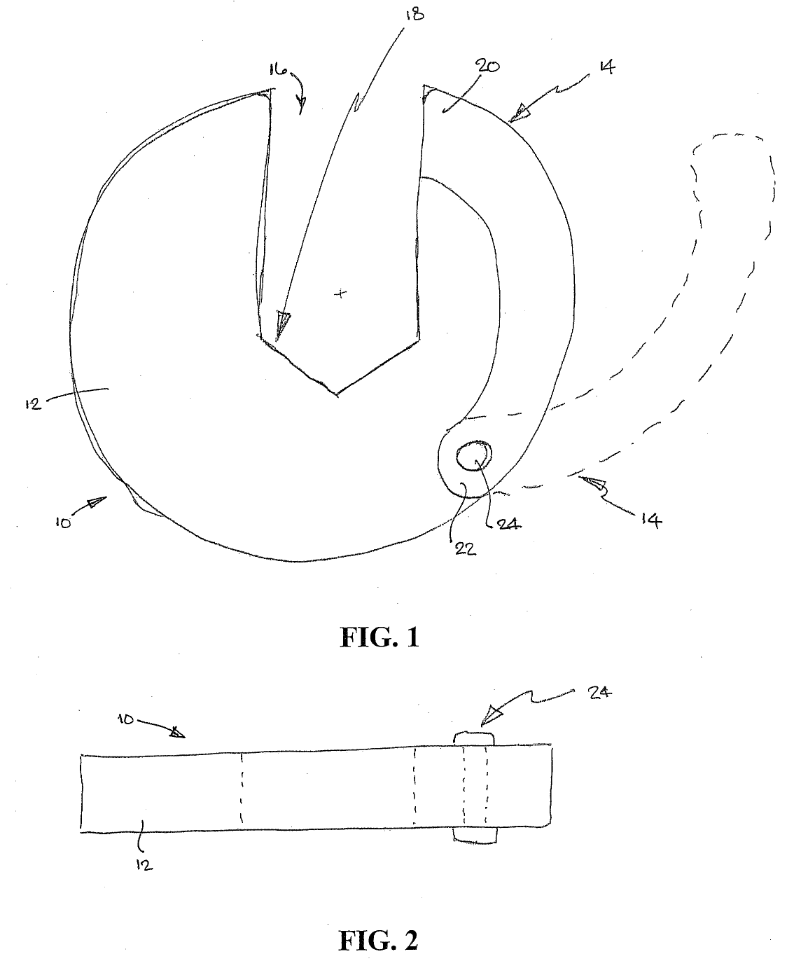

As shown in FIGS. 1 and 2, a torque wrench is generally designated 10. Torque wrench 10 includes a body 12 and a handle 14. Body 12 has a notch 16 formed therein. Notch 16 includes an interface 18 for engaging a head of a mechanical fastener. In a preferred embodiment of the invention, the mechanical fastener has a hex-shaped head. One of ordinary skill in the art, however, will appreciate that the mechanical fastener head may have any suitable geometric shape, to which interface 18 of notch 16 provides a corresponding counterpart. Body 12 is preferably composed of a metal material, but may also be composed of an injection molded material.

Handle 14 is pivotally connected to body 12. Handle 14 includes a free end 20 and an attached end 22. Attached end 22 of handle 14 is pivotally connected to body 12 by a hinge 24. Handle 14 is movable between a stowed position, which is shown in solid lines in FIG. 1, and a deployed position, which is shown in dashed lines in FIG. 1.

Hinge 24 includes a clutch to limit the torque applied to by torque wrench 10 to a mechanical fastener. In addition, torque wrench 10 includes a coil spring (not shown). The coil spring is provided about hinge 14 and biases handle 14 to the stowed position.

When handle 14 is in the stowed position, free end 20 of handle 14 abuts body 12, giving torque wrench 10 a generally disc-like shape. Torque wrench 10 is compact in its stowed position and may be easily toted around in a golf bag or a golf fitting cart.

To operate torque wrench 10, a user would place notch 16 of body 12 about the head of a mechanical fastener. The user then grasps handle 14 and rotates free end 20 of handle 14 away from body 12 to the deployed position. With handle 14 in the deployed position, the user could apply a force on handle 14 to tighten the mechanical fastener. Torque wrench 10 may produce an audible indication to notify the user of when an appropriate amount of torque has been applied to the mechanical fastener.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

What is claimed is:

1. A torque wrench comprising:
a body having a notch formed therein, the notch having an interface for engaging a geometrically-shaped head of a mechanical fastener; and
a handle having a free end and an attached end, the attached end of the handle being pivotably connected to the body by a hinge, the handle being movable between a stowed position and a deployed position,
wherein when the handle is in the stowed position, the free end of the handle abuts the body and the torque wrench has a generally disc-like shape.

2. The torque wrench according to claim 1, wherein the hinge includes a clutch to limit a torque applied to the mechanical fastener.

3. The torque wrench according to claim 1, wherein the handle is biased in the stowed position.

4. The torque wrench according to claim 3, further comprising a coil spring disposed about the hinge, the coil spring biasing the handle to the stowed position.

5. The torque wrench according to claim 1, wherein the body and the handle are comprised of a metal material.

6. The torque wrench according to claim 1, wherein the body and the handle are comprised of an injection molded material.

7. The torque wrench according to claim 1, wherein the notch is generally hex-shaped and adapted to engage a hex-shaped head of the mechanical fastener.
